(19) United States
(12) Patent Application Publication
(10) Pub. No.: US 2014/0144633 A1
(43) Pub. Date: May 29, 2014

(54) Methods of Enhancing Fracture Conductivity of Subterranean Formations Propped with Cement Packs

(71) Applicant: Halliburton Energy Services, Inc., Houston, TX (US)

(72) Inventors: Philip D. Nguyen, Houston, TX (US); Jimmie D. Weaver, Duncan, OK (US); Michael W. Sanders, Houston, TX (US); Jason E. Bryant, Houston, TX (US); Loyd E. East, Houston, TX (US); Guillermo Antonio Izquierdo, Villahermosa, CO (US); Leopoldo Sierra, Houston, TX (US); Timothy H. Hunter, Duncan, OK (US)

(73) Assignee: Halliburton Energy Services, Inc., Houston, TX (US)

(21) Appl. No.: 13/687,186

(22) Filed: Nov. 28, 2012

(51) Int. Cl. E21B 43/26; C09K 8/80; C09K 8/62

(52) U.S. Cl. CPC E21B 43/261; C09K 8/62; C09K 8/80
USPC 166/281; 166/283

(57) ABSTRACT

Methods of treating a subterranean formation including providing a wellbore in a subterranean formation having at least one fracture; providing an expandable cementitious material; introducing the expandable cementitious material into the at least one fracture in the subterranean formation; curing the expandable cementitious material so as to form a cement pack, wherein the curing of the expandable cementitious material expands the expandable cementitious material such that at least one microfracture is created within the at least one fracture in the subterranean formation; and acid-fracturing the at least one fracture in the subterranean formation.

### BACKGROUND

The present invention provides methods of enhancing fracture conductivity within propped subterranean formations using a cementitious material and methods of delivering and/or treating such cementitious material.

Subterranean wells (e.g., hydrocarbon producing wells, water producing wells, and injection wells) are often stimulated by hydraulic fracturing treatments. In hydraulic fracturing treatments, a viscous treatment fluid is pumped into a portion of a subterranean formation at a rate and pressure such that the subterranean formation breaks down and one or more fractures are formed. While the treatment fluid used to initiate the fracture is generally solids-free, typically, particulate solids, such as graded sand, are suspended in a later portion of the treatment fluid and then deposited into the fractures. These particulate solids, or “proppants,” serve to prop the fracture open (e.g., keep the fracture from fully closing) after the hydraulic pressure is removed. By keeping the fracture from fully closing, the proppants aid in forming conductive paths through which produced fluids, such as hydrocarbons, may flow.

The degree of success of a fracturing operation depends, at least in part, upon fracture porosity and conductivity once the fracturing operation is complete and production is begun. Traditional fracturing operations place a large volume of proppant suspended in an aqueous fluid into a fracture to form a “proppant pack” in order to ensure that the fracture does not close completely upon removing the hydraulic pressure. The ability of proppants to maintain a fracture open depends upon the ability of the proppants to withstand fracture closure and, therefore, is typically proportional to the volume of proppants placed in the fracture. The porosity of a proppant pack within a fracture is related to the interconnected interstitial spaces between abutting proppants. Thus, the fracture porosity is closely related to the strength of the placed proppant and tight proppant packs are often unable to produce highly conductive channels within a fracture, while a reduced volume of proppant is unable to withstand fracture closure. Moreover, hydraulic fracturing in soft rock formations, such as carbonate formations, is often inadequate to create conductive pathways because the proppant and carbonate formation together are unable to withstand closure pressure.

The substantial volume of aqueous fluid introduced into a formation during traditional fracturing treatments may also result in dilution of later-placed treatment fluids, impairment of produced fluid flow due to formation fluid retention, or damaged formation portions causing reduced hydrocarbon permeability due to fluid-induced swelling of the formation. Additionally, traditional hydraulic fracturing treatments alone may create only shallow fractures near the wellbore head, substantially impairing the conductivity potential of a subterranean formation as a whole.

One way proposed to combat problems inherent in tight proppant packs involves placing degradable particulates within the proppant pack, which upon encountering a certain activating trigger (e.g., temperature, pH, etc.) will degrade and leave behind channels within the proppant pack. However, such degradable particulates are often unpredictable and may lead to unconnected and independent interstitial spaces within the proppant pack that fail to enhance conductivity, but rather form pockets that trap produced fluids. Additionally, the placement of the degradable particulates may not be predictably uniform throughout the proppant pack, again leaving only pockets that trap produced fluids rather than contributing to an interconnected interstitial network for fluids to flow.

In order to overcome some of the drawbacks of traditional hydraulic fracturing, techniques have been developed to reduce the amount of aqueous fluid required in a fracturing operation and/or to replace or supplement traditional hydraulic fracturing with techniques to extend fractures deep within a formation and prevent complete fracture closure. These techniques may collectively be referred to as enhanced oil recovery techniques. An example of one such enhanced oil recovery technique is fracture-acidizing, in which an acid (e.g., hydrochloric acid) is injected into a formation above the formation fracture gradient in order to fracture the formation and simultaneously etch channels in the face of the fracture in a non-uniform pattern such that the channels remain open after the pressure is removed and the fracture closes. Fracture-acidizing is limited due to acid spending or leakoff, resulting in fracture extension termination. Fracture-acidizing may also be unable to overcome the drawbacks of fracturing soft rock formations, failing to maintain conductive channels after fracture closure.

Another example of an enhanced oil recovery technique is the use of explosives or propellants to stimulate shockwaves in a subterranean formation and generate fractures therein. While this technique is effective at stimulating deep fractures within a subterranean formation, handling of explosives or propellants poses great threat to operators during well stimulation. Additionally, the explosives or propellants may detonate at unplanned or unpredictable intervals within the formation, interfering with the conductivity potential of the well. Therefore, a method of safely and predictably fracturing and generating highly conductive channels within a propped fracture in a subterranean formation may be of benefit to one of ordinary skill in the art.

### SUMMARY OF THE INVENTION

The present invention provides methods of enhancing fracture conductivity within propped subterranean formations using a cementitious material and methods of delivering and/or treating such cementitious material.

In one embodiment, the present invention provides a method comprising: providing a wellbore in a subterranean formation having at least one fracture; providing an expandable cementitious material; introducing the expandable cementitious material into the at least one fracture in the subterranean formation; curing the expandable cementitious material so as to form a cement pack, wherein the curing of the expandable cementitious material expands the expandable cementitious material such that at least one microfracture is created within the at least one fracture in the subterranean formation; and acid-fracturing the at least one fracture in the subterranean formation.

In other embodiments, the present invention provides a method comprising: providing a wellbore in a subterranean formation having at least one fracture; providing an expandable cementitious material; introducing the expandable cementitious material into the at least one fracture in the subterranean formation; and curing the expandable cementitious material so as to form a cement pack, wherein the curing of the expandable cementitious material expands the expandable cementitious material such that at least one microfracture is created within the at least one fracture in the subterranean formation.

In still other embodiments, the present invention provides a method comprising: providing a wellbore in a subterranean formation having at least one fracture; providing an expandable cementitious material; providing a breakable gel fluid; introducing the expandable cementitious material into the at least one fracture in the subterranean formation; introducing the breakable gel fluid into the wellbore in the subterranean formation so as to prevent the expandable cementitious material from migrating out of the at least one fracture in the subterranean formation; curing the expandable cementitious material so as to form a cement pack, wherein the curing of the expandable cementitious material expands the expandable cementitious material such that at least one microfracture is created within the at least one fracture in the subterranean formation; breaking the breakable gel fluid; and removing the broken breakable gel fluid from the subterranean formation.

The features and advantages of the present invention will be readily apparent to those skilled in the art upon a reading of the description of the preferred embodiments that follows.

### BRIEF DESCRIPTION OF THE DRAWINGS

The following figures are included to illustrate certain aspects of the present invention, and should not be viewed as exclusive embodiments. The subject matter disclosed is capable of considerable modifications, alterations, combinations, and equivalents in form and function, as will occur to those skilled in the art and having the benefit of this disclosure.

FIG. 1 is a cross-sectional view of a main wellbore penetrating a subterranean formation having cement pillars located in a fracture extending from the main wellbore.

FIG. 2 is a cross-sectional view of a main wellbore penetrating a subterranean formation having multiple lateral wellbores extending therefrom and having cement pillars located in at least one fracture extending from a lateral wellbore.

### DETAILED DESCRIPTION

The present invention provides methods of enhancing fracture conductivity within propped subterranean formations using a cementitious material and methods of delivering and/or treating such cementitious material. The cementitious material of the present invention may be introduced alone as a “cement pack” within a fracture in a wellbore in a subterranean formation as a cementitious slurry that largely fills the interior of a fracture or a portion of the interior of a fracture (e.g., the cementitious material is packed into the fracture without spacer fluid to form). In other embodiments, the cementitious material of the present invention may be introduced in the form of cementitious material aggregates or cement pillars within a fracture in a subterranean formation. As used herein, the term “cementitious material aggregates” and related terms such as “cement pillars” refer to coherent cluster of wetted, settable cementitious material that remains a coherent body when placed into a carrier fluid and/or a fracture. The cementitious material aggregate remains a coherent body that does not generally become dispersed into smaller bodies without application of shear.

The methods of the present invention may be used in any wellbore in a subterranean formation. As used herein, the term “wellbore” refers to main wellbores (both horizontal and vertical) and lateral wellbores. As used herein, the term “lateral wellbore” refers to a wellbore that extends or radiates from the main wellbore in any direction. Lateral wellbores may be drilled to bypass an unusable portion of a main wellbore or to access particular portions of a subterranean formation without drilling a second main wellbore. Lateral wellbores are often tight formations that may require the use of a hydrojetting tool to treat the lateral wellbore for stimulation operations.

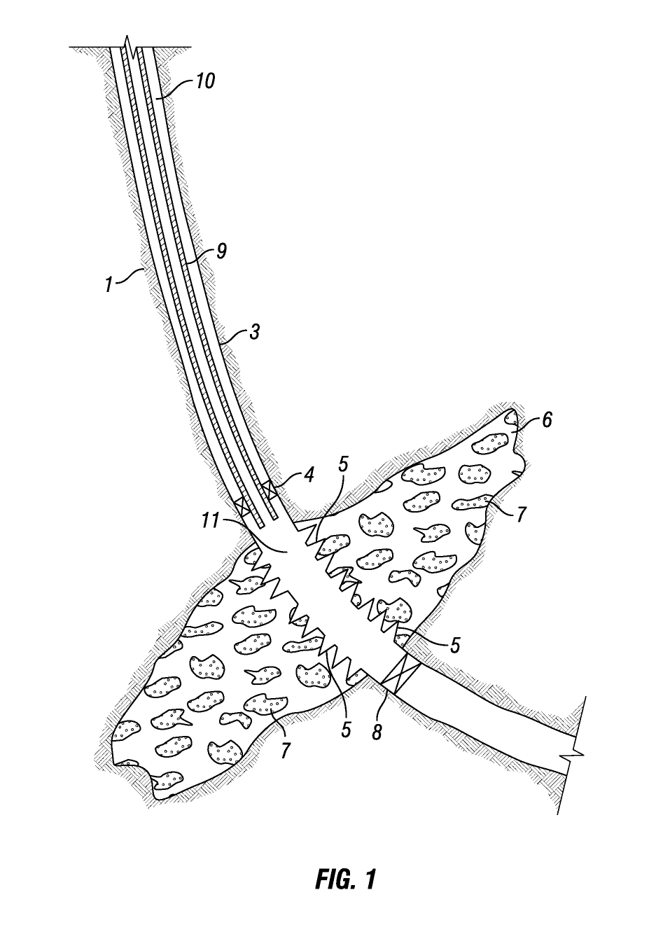

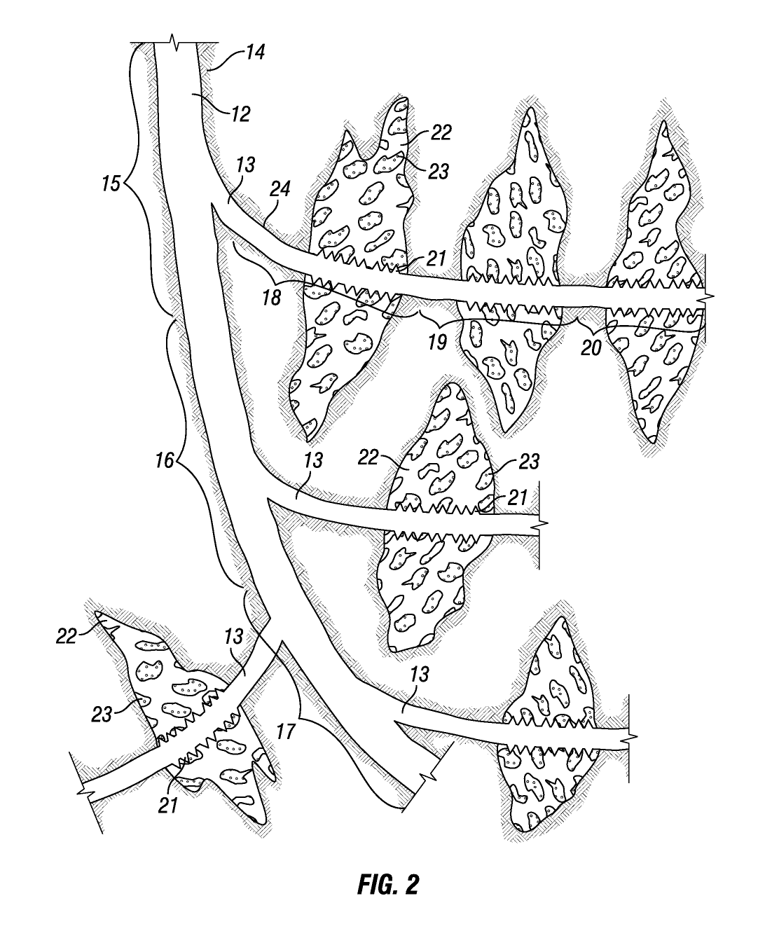

Referring now to the drawings, FIGS. 1 and 2 depict application of an embodiment of the present invention in a main wellbore and a lateral wellbore, respectfully. FIG. 1 depicts main wellbore 10 in subterranean formation 1. A packer depicted by upper packer 4 and lower packer 8 are set in main wellbore 10 to form a packer-to-wellbore bond with the main wellbore formation surface 3. The upper packer 4, lower packer 8, and main wellbore 10 define fracture treatment interval 11. Injection tubing 2 is set in the main wellbore in order to facilitate introduction of treatment fluids into fracture treatment interval 11. Using conventional methods known in the art (e.g., a perforation gun or a hydrojetting tool), a plurality of perforations 5 extend into through main wellbore formation surface 3 and into subterranean formation 1. Subterranean formation 1 is stimulated by conventional methods to create fracture 6 (e.g., by hydraulic fracturing with a viscous fluid) extending through perforations 5 in main wellbore 10 and into subterranean formation 1. The cement slurry of the present invention is placed within fracture 6 by any of the methods disclosed herein so as to form cement pillars 7, thereby providing a cement pillar propped fracture.

FIG. 2 depicts main wellbore 12 having multiple lateral wellbores 13 in subterranean formation 14. The multiple lateral wellbores 13 may be located at one or more of top portion 15 of main wellbore 12, middle portion 16 of main wellbore 12, or bottom portion 17 of main wellbore 12. Using the methods disclosed herein (e.g., a hydrojetting tool), a plurality of perforations 21 extend through lateral wellbore formation surface 22 and into subterranean formation 14, and may be located at one or more of at top portion 18 of lateral wellbore 13, middle portion 19 of lateral wellbore 13, or bottom portion 20 of lateral wellbore 13. Subterranean formation 14 is stimulated by the methods disclosed herein to create fracture 22 through perforations 21 in lateral wellbore 13 and into subterranean formation 14. The cement slurry of the present invention is placed within fracture 22 by any of the methods disclosed herein so as to form cement pillars 23, thereby providing a cement pillar propped fracture. As used herein, the term “top portion” of a wellbore refers to the point of initiation of the wellbore (e.g., the wellbore head exposed to open air or the entrance of a lateral wellbore from the main wellbore), the term “bottom portion” refers to the point of termination of the wellbore, and the term “middle portion” refers to the length of the wellbore therebetween.

In some embodiments, the present invention provides for a method comprising providing a wellbore in a subterranean formation having at least one fracture; providing an expandable cementitious material; introducing the expandable cementitious material into the at least one fracture; curing the expandable cementitious material, wherein the curing of the expandable cementitious material expands the expandable cementitious material such that at least one microfracture is created within the at least one fracture in the subterranean formation; and acid-fracturing the at least one fracture in the subterranean formation. Acid-fracturing may operate synergistically with the expandable cementitious material to enhance the conductive channels created in the fracture to improve the flow of produced fluids, both when the expandable cementitious material is introduced as a cement pack or a cement pillar. The acid-fracturing step of the present invention is performed after the expandable cementitious material is cured within a fracture in a subterranean formation by injecting an acid into the formation above the formation fracture gradient. Acid-fracturing enhances conductivity because after the expandable cementitious material expands and creates microfractures within the fracture, the acid from the acid-fracturing creates differential etching in the fracture resulting in ridges of non-uniform acid dissolution that, when the hydraulic pressure is removed, provides additional conductive channels, some of which may also intersect the microfractures. Acid-fracturing may also be used as a tail-in treatment with the expandable cementitious material to maintain near wellbore conductivity. Although it is preferred that acid-fracturing be performed after an expandable cement pack or cement pillar is placed in a fracture and cures, acid-fracturing may also synergistically improve the conductivity of fractures propped with non-expandable cement pillars comprised of cementitious material. The cement pillars are capable of withstanding the fracture closure pressures to allow the acid to etch non-uniform channels within the fracture to enhance hydraulic fracturing and flow conductivity.

In some embodiments, the present invention provides methods of using a cement slurry comprising a cementitious material and a breakable foamed carrier fluid, wherein the cementitious material is capable of consolidating to form a plurality of cementitious material aggregates and wherein the breakable foamed carrier fluid is capable of coating and isolating the cementitious material aggregates while being placed downhole. The cementitious material may be introduced into the breakable foamed carrier fluid to form the cement slurry by mixing. In preferred embodiments, the cementitious material is introduced into the breakable foamed carrier fluid in discrete blobs to form the cement slurry. The cement slurry is introduced into at least one fracture within the subterranean formation and, once placed, the cementitious material aggregates cure to form cement pillars within the fracture. Also, once placed into the fracture, the breakable foamed carrier fluid is broken and then removed from the subterranean formation. In some embodiments, it may be preferable that the breakable foamed carrier fluid does not break until the cementitious material aggregates have cured or substantially cured. In other embodiments, the curing of the cementitious material aggregates may occur simultaneously with the breaking of the foamed carrier fluid. In some embodiments, the cementitious material may be an expandable cementitious material. In still other embodiments, the cement pillar propped fracture (either by cementitious material or expandable cementitious material) may be acid fracturized after the curing of the cementitious material aggregates.

The fractures of the present invention may be created by any hydraulic fracturing technique known in the art. In some embodiments, hydraulic fracturing may be achieved by pumping a fracturing fluid at or above the fracture gradient through perforations extending from the wellbore into the formation. In some cases the perforations extend through a cement sheath separating the wellbore from the formation. Perforations may be formed using generally circular-shaped charges in order to form the perforations after detonation of the charge. Perforations may also be formed using a hydrojetting tool with a generally circular-shaped hydrojetting nozzle using a jetting fluid comprising a base fluid and/or a cutting particulate.

Unlike traditional fracturing techniques, however, hydraulic fracturing techniques for use in the methods of the present invention may preferably be performed by pumping a fracturing fluid at or above the fracture gradient through slots in a formation. As used herein, the term “slots” refers to a shaped formation opening in which the shape is a quadrilateral having two directions, where one direction is longer than the other (e.g. a rectangle). In some embodiments, the slots may be at least 3 times as long as wide. The particular shape of the slots used in the present invention will depend upon multiple factors including, for example, the type of formation, the type of cementitious material used, and the size of the fracture to be propped.

Slots may be formed using slot-shaped charges such that the slot is created after detonation of the charge. Slots may also be formed using a hydrojetting tool with a slot-shaped hydrojetting nozzle. The slots may be made using the hydrojetting tool with a jetting fluid comprising a base fluid alone or a base fluid and a cutting particulate. Slots may also be created using a non-slot-shaped hydrojetting tool by oscillating or reciprocating the nozzle of the hydrojetting tool in a manner that carves out a slot-shaped opening in the formation. Slots are particularly beneficial for use in the present invention when cementitious material aggregates are placed within the fracture. The slots help the cementitious material aggregates or cement pillars to remain substantially intact as they enter the fracture, which may increase the conductivity of the fracture. Perforations, on the other hand, may result in the mixing or breaking of cementitious material aggregates as they encounter shear through small perforation openings (or openings that do not comport with the size and shape of the cementitious material aggregates) prior to being placed within the fracture.

Suitable base fluids for use in any of the fluids of the present invention requiring a base fluid (e.g., jetting fluid, breakable gel fluid, breakable foamed carrier fluid, degradable gel fluid) may include, but are not limited to, oil-based fluids, aqueous-based fluids, aqueous-miscible fluids, water-in-oil emulsions, or oil-in-water emulsions. Suitable oil-based fluids may include alkanes, olefins, aromatic organic compounds, cyclic alkanes, paraffins, diesel fluids, mineral oils, desulfurized hydrogenated kerosenes, and any combination thereof. Suitable aqueous-based fluids may include fresh water, saltwater (e.g., water containing one or more salts dissolved therein), brine (e.g., saturated salt water), seawater, and any combination thereof. Suitable aqueous-miscible fluids may include, but not be limited to, alcohols, e.g., methanol, ethanol, n-propanol, isopropanol, n-butanol, sec-butanol, isobutanol, and t-butanol; glycerins; glycols, e.g., polyglycols, propylene glycol, and ethylene glycol; polyglycol amines; polyols; any derivative thereof; any in combination with salts, e.g., sodium chloride, calcium chloride, calcium bromide, zinc bromide, potassium carbonate, sodium formate, potassium formate, cesium formate, sodium acetate, potassium acetate, calcium acetate, ammonium acetate, ammonium chloride, ammonium bromide, sodium nitrate, potassium nitrate, ammonium nitrate, ammonium sulfate, calcium nitrate, sodium carbonate, and potassium carbonate; any in combination with an aqueous-based fluid; and any combination thereof. Suitable water-in-oil emulsions, also known as invert emulsions, may have an oil-to-water ratio from a lower limit of greater than about 50:50, 55:45, 60:40, 65:35, 70:30, 75:25, or 80:20 to an upper limit of less than about 100:0, 95:5, 90:10, 85:15, 80:20, 75:25, 70:30, or 65:35 by volume in the base fluid, where the amount may range from any lower limit to any upper limit and encompass any subset therebetween. Examples of suitable invert emulsions include those disclosed in U.S. Pat. No. 5,905,061 entitled “Invert Emulsion Fluids Suitable for Drilling” filed on May 23, 1997, U.S. Pat. No. 5,977,031 entitled “Ester Based Invert Emulsion Drilling Fluids and Muds Having Negative Alkalinity” filed on Aug. 8, 1998, U.S. Pat. No. 6,828,279 entitled “Biodegradable Surfactant for Invert Emulsion Drilling Fluid” filed on Aug. 10, 2001, U.S. Pat. No. 7,534,745 entitled “Gelled Invert Emulsion Compositions Comprising Polyvalent Metal Salts of an Organophosphonic Acid Ester or an Organophosphinic Acid and Methods of Use and Manufacture” filed on May 5, 2004, U.S. Pat. No. 7,645,723 entitled “Method of Drilling Using Invert Emulsion Drilling Fluids” filed on Aug. 15, 2007, and U.S. Pat. No. 7,696,131 entitled “Diesel Oil-Based Invert Emulsion Drilling Fluids and Methods of Drilling Boreholes” filed on Jul. 5, 2007, each of which are incorporated herein by reference in their entirety. It should be noted that for water-in-oil and oil-in-water emulsions, any mixture of the above may be used including the water being and/or comprising an aqueous-miscible fluid.

The cutting particulate suitable for use in the jetting fluids of the present invention may be any proppant particulate suitable for use in a subterranean operation that is capable of withstanding the formation pressure so as to create a perforation or slot therein. Suitable cutting particulates may include, but are not limited to, sand, bauxite, ceramic materials, glass materials, polymer materials, polytetrafluoroethylene materials, nut shell pieces, cured resinous particulates comprising nut shell pieces, seed shell pieces, cured resinous particulates comprising seed shell pieces, fruit pit pieces, cured resinous particulates comprising fruit pit pieces, wood, composite particulates, and combinations thereof. Suitable composite particulates may comprise a binder and a filler material wherein suitable filler materials include silica, alumina, fumed carbon, carbon black, graphite, mica, titanium dioxide, meta-silicate, calcium silicate, kaolin, talc, zirconia, boron, fly ash, hollow glass microspheres, solid glass, and combinations thereof. The cutting particulates of the present invention may additionally be degradable particulates, including any of those disclosed herein.

The cementitious material of the present invention may be any cementitious material suitable use in a subterranean operation, including hydraulic and non-hydraulic cementitious materials. In preferred embodiments, the cementitious material is a hydraulic cement. Hydraulic cements harden by the process of hydration due to chemical reactions to produce insoluble hydrates (e.g., calcium hydroxide) that occur independent of the cement's water content (e.g., hydraulic cements can harden even under constantly damp conditions). Thus, hydraulic cements are preferred because they are capable of hardening regardless of the water content of a particular subterranean formation. Suitable hydraulic cements include, but are not limited to Portland cement; Portland cement blends (e.g., Portland blast-furnace slag cement and/or expansive cement); non-Portland hydraulic cement (e.g., super-sulfated cement, calcium aluminate cement, and/or high magnesium-content cement); and any combination thereof.

In some preferred embodiments, the cementitious material is an expandable cementitious material. The expandable cementitious material of the present invention may be any expandable cementitious material known in the art. Suitable expandable cementitious materials may include expandable agents such as, but not limited to, calcium oxide; magnesium oxide; any derivatives thereof; and any combinations thereof. Examples of suitable expandable cementitious materials include, but are not limited to, those disclosed in U.S. Pat. No. 4,046,583 entitled “Methods of Producing Expansive and High Strength Cementitious Pastes, Mortars and Concretes” and U.S. Pat. No. 4,797,159 entitled “Expandable Cement Composition,” each of which is incorporated herein by reference in their entirety. Suitable examples of commercially available expandable cementitious materials include, but are not limited to, Dexpan® Non-Explosive Demolition Agent by Dexpan® USA in Sunland Park, N. Mex.; Quikrete® Anchoring Cement by Quikrete® Companies in Atlanta, Ga.; Rockite® Expansion Cement by Hartline Products Co., Inc. in Cleveland, Ohio; and CRL Kwixset® Cement from Hartline Products Co., Inc. in Cleveland, Ohio.

The expandable cementitious materials for use in the present invention may expand as they cure, such that the area of the expandable cementitious material occupied within the fracture is a first amount and as the expandable cementitious material cures, the area it occupied within the fracture increases to a second, larger amount. In some embodiments, the expandable cementitious material may expand up to 4 times the original size of the uncured expandable cementitious material. By increasing the area occupied by the expandable cementitious material, the expandable cementitious material may overcome the in-situ stresses of the formation to create microfractures within the fracture. These microfractures may increase the conductivity of the fracture. The type and composition of the expandable cementitious material may be manipulated in order to control the magnitude of in-situ pressures which it may overcome. By doing so, the amount and size of the microfractures created may be controlled and/or predicted. The expandable cementitious material may be intermixed with cementitious material that is not expandable in order to achieve the counter stress pressures for a particular formation. One of ordinary skill in the art, with the benefit of this disclosure, will recognize the type and amount of cementitious or expandable cementitious material to include in a particular application.

The expandable cementitious materials of the present invention may also be capable of acting as a barrier to prevent direct fracture growth or extension in multiple-stage hydraulic fracturing operations. In multiple-stage hydraulic fracturing operations, multiple intervals of a subterranean formation may be fractured at different time periods. The expandable cementitious materials of the present invention may act to prevent already existing fractures from growing during such multiple-stage hydraulic fracturing operations. The methods of the present invention may employ multiple-stage hydraulic fracturing (e.g., through use of a hydrojetting tool) beginning near the mouth of the wellbore or near the deepest drilled portion of the wellbore and in any order between such that the interval first fractured need not be close to the interval fractured thereafter. Additionally, because the expandable cementitious material is nonreactive with subterranean formations, it is capable of producing a filtercake, which controls leakoff into natural fractures and allows deeper effective fracture lengths.

The synergistic combination of expandable cementitious material and acid-fracturing disclosed by the present invention may also overcome the difficulties associated with hydraulic fracturing (including acid-fracturing) soft rock formations (e.g., carbonate rock). Because the expandable cementitious material of the present invention may be tightly packed into a fracture and be capable of combating the in-situ formation closure stresses, while also expanding and generating conductive channels.

In some embodiments, the cementitious material or expandable cementitious material of the present invention may include a pozzolanic material. Pozzolanic materials may aid in increasing the density and strength of the cementitious material. As used herein, the term “pozzolanic material” refers to a siliceous material that, while not being cementitious, is capable of reacting with calcium hydroxide, which may be produced during hydration of the cementitious material. Because calcium hydroxide accounts for a sizable portion of most hydrated hydraulic cements and because calcium hydroxide does not contribute to the cement's properties, the combination of cementitious and pozzolanic materials may synergistically enhance the strength and quality of the cement. Any pozzolanic material that is reactive with the cementitious or expandable cementitious material may be used in the methods of the present invention. Suitable pozzolanic materials include, but are not limited to silica fume; metakaolin; fly ash; diatomaceous earth; calcined or uncalcined diatomite; calcined fullers earth; pozzolanic clays; calcined or uncalcined volcanic ash; bagasse ash; pumice; pumicite; rice hull ash; natural and synthetic zeolites; slag; vitreous calcium aluminosilicate; and any combinations thereof. An example of a suitable commercially-available pozzolanic material is POZMIX®-A available from Halliburton Energy Services, Inc. of Houston, Tex. In some embodiments of the present invention, the pozzolanic material may be present in an amount of about 5% to about 60% w/w of the dry cementitious material. In preferred embodiments, the pozzolanic material is present in an amount of about 5% to about 30% w/w of the dry cementitious material.

In some embodiments, the cementitious material or expandable cementitious material of the present invention may further comprise any cement additive capable of use in a subterranean operation. Cement additives may be added to modify the characteristics of the cementitious material. Such additives include, but are not limited to, a cement accelerator; a cement retarder; a fluid-loss additive; a cement dispersant; a cement extender; a weighting agent; a lost circulation additive; and any combinations thereof. The cement additives of the present invention may be in any form, including powder form or liquid form.

The cementitious material or expandable cementitious material may be held into place (e.g., prevented from escaping a fracture) by the introduction of a breakable gel fluid into the wellbore in the subterranean formation (e.g., by placing the breakable gel fluid into the wellbore or into the near-wellbore portion of the fracture itself). The breakable gel fluid pushes the cementitious material toward the point of the fracture furthest from the wellbore and prevents the cementitious material from migrating out of the fracture and into the wellbore. Avoiding such migration is generally important, as it may tend to prevent the cementitious material from forming a cement pack capable of withstanding fracture closure pressure, thereby hindering conductivity of the fracture. Additionally, when the cementitious material is an expandable cementitious material, migration out of the fracture may prevent the expandable cementitious material from creating microfractures within the fracture because the expandable cementitious material is not in sufficient quantity to place pressure on the fracture walls.

In some embodiments, the breakable gel fluid of the present invention may additionally be introduced into a fracture in a subterranean formation intermittently with the cementitious or expandable cementitious material so as to alternate the breakable gel fluid and the cementitious or expandable cementitious material within the at least one fracture in the subterranean formation. After placement curing the cementitious or expandable cementitious material, the breakable gel fluid is broken and removed from the subterranean formation so as to leave behind discrete spaces between individual cement packs (e.g., cementitious or expandable cementitious pillars).

The breakable gel fluid of the present invention may comprise a base fluid, a gelling agent, a crosslinking agent, and a gel breaker. The breakable gel fluid may additionally comprise a particulate, such as sand. The base fluids suitable for use in the present invention may be any base fluids that may be used in subterranean operations. Suitable base fluids for use in conjunction with the present invention may include, but not be limited to,

The gelling agents suitable for use in the present invention may comprise any substance (e.g. a polymeric material) capable of increasing the viscosity of the breakable gel fluid. In certain embodiments, the gelling agent may comprise one or more polymers that have at least two molecules that are capable of forming a crosslink in a crosslinking reaction in the presence of a crosslinking agent, and/or polymers that have at least two molecules that are so crosslinked (i.e., a crosslinked gelling agent). The gelling agents may be naturally-occurring gelling agents, synthetic gelling agents, or a combination thereof. The gelling agents also may be cationic gelling agents, anionic gelling agents, or a combination thereof. Suitable gelling agents include, but are not limited to, polysaccharides, biopolymers, and/or derivatives thereof that contain one or more of these monosaccharide units: galactose, mannose, glucoside, glucose, xylose, arabinose, fructose, glucuronic acid, or pyranosyl sulfate. Examples of suitable polysaccharides include, but are not limited to, guar gums (e.g., hydroxyethyl guar, hydroxypropyl guar, carboxymethyl guar, carboxymethylhydroxyethyl guar, and carboxymethylhydroxypropyl guar (“CMHPG”)), cellulose derivatives (e.g., hydroxyethyl cellulose, carboxyethylcellulose, carboxymethylcellulose, and carboxymethylhydroxyethylcellulose), xanthan, scleroglucan, succinoglycan, diutan, and combinations thereof. In certain embodiments, the gelling agents comprise an organic carboxylated polymer, such as CMHPG.

Suitable synthetic polymers include, but are not limited to, 2,2′-azobis(2,4-dimethyl valeronitrile), 2,2′-azobis(2,4-dimethyl-4-methoxy valeronitrile), polymers and copolymers of polyvinylpyrrolidone; acrylamide ethyltrimethyl ammonium chloride, acrylamide, acrylamido- and methacrylamido-alkyl trialkyl ammonium salts, acrylamidomethylpropane sulfonic acid, acrylamidopropyl trimethyl ammonium chloride, acrylic acid, dimethylaminoethyl methacrylamide, dimethylaminoethyl methacrylate, dimethylaminopropyl methacrylamide, dimethylaminopropylmethacrylamide, dimethyldiallylammonium chloride, dimethylethyl acrylate, fumaramide, methacrylamide, methacrylamidopropyl trimethyl ammonium chloride, methacrylamidopropyldimethyl-n-dodecylammonium chloride, methacrylamidopropyldimethyl-n-octylammonium chloride, methacrylamidopropyltrimethylammonium chloride, methacryloylalkyl trialkyl ammonium salts, methacryloylethyl trimethyl ammonium chloride, methacrylylamidopropyldimethylcetylammonium chloride, N-(3-sulfopropyl)-N-methacrylamidopropyl-N,N-dimethyl ammonium betaine, N,N-dimethylacrylamide, N-methylacrylamide, nonylphenoxypoly(ethyleneoxy)ethylmethacrylate, partially hydrolyzed polyacrylamide, poly 2-amino-2-methyl propane sulfonic acid, polyvinyl alcohol, sodium 2-acrylamido-2-methylpropane sulfonate, quaternized dimethylaminoethylacrylate, quaternized dimethylaminoethylmethacrylate, and derivatives and combinations thereof. In certain embodiments, the gelling agent comprises an acrylamide/2-(methacryloyloxy)ethyltrimethylammonium methyl sulfate copolymer. In certain embodiments, the gelling agent may comprise an acrylamide/2-(methacryloyloxy)ethyltrimethylammonium chloride copolymer. In certain embodiments, the gelling agent may comprise a derivatized cellulose that comprises cellulose grafted with an allyl or a vinyl monomer, such as those disclosed in U.S. Pat. Nos. 4,982,793, 5,067,565, and 5,122,549, the entire disclosures of which are incorporated herein by reference.

Additionally, polymers and copolymers that comprise one or more functional groups (e.g., hydroxyl, cis-hydroxyl, carboxylic acids, derivatives of carboxylic acids, sulfate, sulfonate, phosphate, phosphonate, amino, or amide groups) may be used as gelling agents.

The gelling agent may be present in the breakable gel fluids useful in the methods of the present invention in an amount sufficient to provide the desired viscosity. In some embodiments, the gelling agents (i.e., the polymeric material) may be present in an amount in the range of from about 0.1% to about 10% by weight of the breakable gel fluid. In certain embodiments, the gelling agents may be present in an amount in the range of from about 0.15% to about 2.5% by weight of the breakable gel fluid.

In those embodiments of the present invention where it is desirable to crosslink the gelling agent, the breakable gel fluid may comprise one or more crosslinking agents. The crosslinking agents may comprise a borate ion, a metal ion, or similar component that is capable of crosslinking at least two molecules of the gelling agent. Examples of suitable crosslinking agents include, but are not limited to, borate ions, magnesium ions, zirconium IV ions, titanium IV ions, aluminum ions, antimony ions, chromium ions, iron ions, copper ions, magnesium ions, and zinc ions. These ions may be provided by providing any compound that is capable of producing one or more of these ions. Examples of such compounds include, but are not limited to, ferric chloride, boric acid, disodium octaborate tetrahydrate, sodium diborate, pentaborates, ulexite, colemanite, magnesium oxide, zirconium lactate, zirconium triethanol amine, zirconium lactate triethanolamine, zirconium carbonate, zirconium acetylacetonate, zirconium malate, zirconium citrate, zirconium diisopropylamine lactate, zirconium glycolate, zirconium triethanol amine glycolate, zirconium lactate glycolate, titanium lactate, titanium malate, titanium citrate, titanium ammonium lactate, titanium triethanolamine, and titanium acetylacetonate, aluminum lactate, aluminum citrate, antimony compounds, chromium compounds, iron compounds, copper compounds, zinc compounds, and combinations thereof.

Suitable crosslinking agents of the present invention may also comprise at least one degradable group and at least two unsaturated terminal groups. The at least one degradable group may include, but is not limited to, an ester; a phosphate ester; an amide; an acetal; a ketal; an orthoester; a carbonate; an anhydride a silyl ether; an alkene oxide; an ether; an imine; an ether ester; an ester amide; an ester urethane; a carbonate urethane; an amino acid; any derivatives thereof; and any combinations thereof. The at least two unsaturated terminal groups may include, but are not limited to, an unsubstituted ethylenically unsaturated group; a substituted ethylenically unsaturated group; a vinyl group; an allyl group; an acryl group; an unsaturated ester; an acrylate; a methacrylate; a butyl acrylate; an amide; an acrylamide; an ether; a vinyl ether; any derivatives thereof; and any combinations thereof.

In certain embodiments of the present invention, the crosslinking agent may be formulated to remain inactive until it is “activated” by, among other things, certain conditions in the fluid (e.g., pH, temperature, etc.) and/or interaction with some other substance. In some embodiments, the activation of the crosslinking agent may be delayed by encapsulation with a coating (e.g., a porous coating through which the crosslinking agent may diffuse slowly, or a degradable coating that degrades downhole) that delays the release of the crosslinking agent until a desired time or place. The choice of a particular crosslinking agent will be governed by several considerations that will be recognized by one skilled in the art, including but not limited to the following: the type of gelling agent included, the molecular weight of the gelling agent(s), the conditions in the subterranean formation being treated, the safety handling requirements, the pH of the breakable gel fluid, temperature, and/or the desired delay for the crosslinking agent to crosslink the gelling agent molecules.

When included, suitable crosslinking agents may be present in the breakable gel fluids useful in the methods of the present invention in an amount sufficient to provide the desired degree of crosslinking between molecules of the gelling agent. In certain embodiments, the crosslinking agent may be present in the breakable gel fluids of the present invention in an amount in the range of from about 0.005% to about 1% by weight of the breakable gel fluid. In certain embodiments, the crosslinking agent may be present in the breakable gel fluids of the present invention in an amount in the range of from about 0.05% to about 1% by weight of breakable gel fluid. One of ordinary skill in the art, with the benefit of this disclosure, will recognize the appropriate amount of crosslinking agent to include in a breakable gel fluid of the present invention based on, among other things, the temperature conditions of a particular application, the type of gelling agents used, the molecular weight of the gelling agents, the desired degree of viscosification, and/or the pH of the breakable gel fluid.

The breakable gel fluids useful in the methods of the present invention also may include internal gel breakers such as enzyme, oxidizing, acid buffer, or delayed gel breakers. The gel breakers may cause the breakable gel fluids of the present invention to revert to thin fluids that can be produced back to the surface. In some embodiments, the gel breaker may be formulated to remain inactive until it is “activated” by, among other things, certain conditions in the fluid (e.g. pH, temperature, etc.) and/or interaction with some other substance. In some embodiments, the gel breaker may be delayed by encapsulation with a coating (e.g. a porous coatings through which the breaker may diffuse slowly, or a degradable coating that degrades downhole) that delays the release of the gel breaker. In other embodiments the gel breaker may be a degradable material (e.g. polylactic acid or polygylcolic acid) that releases an acid or alcohol in the present of an aqueous liquid. In certain embodiments, the gel breaker used may be present in the breakable gel fluid in an amount in the range of from about 0.0001% to about 200% by weight of the gelling agent. One of ordinary skill in the art, with the benefit of this disclosure, will recognize the type and amount of a gel breaker to include in the breakable gel fluids of the present invention based on, among other factors, the desired amount of delay time before the gel breaks, the type of gelling agents used, the temperature conditions of a particular application, the desired rate and degree of viscosity reduction, and/or the pH of the breakable gel fluid.

In some embodiments, the cementitious or expandable cementitious material may additionally comprise a consolidating agent. The consolidating agent may aid in maintaining the cement slurry composition as it flows in the subterranean formation. Suitable consolidating agents may include, but are not limited to, sand, fibers, non-aqueous tackifying agents, aqueous tackifying agents, emulsified tackifying agents, silyl-modified polyamide compounds, resins, crosslinkable aqueous polymer compositions, polymerizable organic monomer compositions, consolidating agent emulsions, zeta-potential modifying aggregating compositions, silicon-based resins, and binders. Combinations and/or derivatives of these also may be suitable. In some embodiments, a consolidating agent is present in the present invention in an amount in the range from about 0.1% to about 20% by weight of the cementitious material. In preferred embodiments, a consolidating agent is present in the present invention in an amount in the range from about 1% to about 5% by weight of the cementitious material.

Nonlimiting examples of suitable non-aqueous tackifying agents may be found in U.S. Pat. Nos. 7,392,847, 7,350,579, 5,853,048; 5,839,510; and 5,833,000, the entire disclosures of which are herein incorporated by reference. Nonlimiting examples of suitable aqueous tackifying agents may be found in U.S. Pat. Nos. 8,076,271, 7,131,491, 5,249,627 and 4,670,501, the entire disclosures of which are herein incorporated by reference. Nonlimiting examples of suitable crosslinkable aqueous polymer compositions may be found in U.S. Patent Application Publication No. 2010/0160187 (pending) and U.S. Pat. No. 8,136,595 the entire disclosures of which are herein incorporated by reference. Nonlimiting examples of suitable silyl-modified polyamide compounds may be found in U.S. Pat. No. 6,439,309 entitled the entire disclosure of which is herein incorporated by reference. Nonlimiting examples of suitable resins may be found in U.S. Pat. Nos. 7,673,686; 7,153,575; 6,677,426; 6,582,819; 6,311,773; and 4,585,064 as well as U.S. Patent Application Publication No. 2008/0006405 (abandoned) and U.S. Pat. No. 8,261,833, the entire disclosures of which are herein incorporated by reference. Nonlimiting examples of suitable polymerizable organic monomer compositions may be found in U.S. Pat. No. 7,819,192, the entire disclosure of which is herein incorporated by reference. Nonlimiting examples of suitable consolidating agent emulsions may be found in U.S. Patent Application Publication No. 2007/0289781 (pending) the entire disclosure of which is herein incorporated by reference. Nonlimiting examples of suitable zeta-potential modifying aggregating compositions may be found in U.S. Pat. Nos. 7,956,017 and 7,392,847, the entire disclosures of which are herein incorporated by reference. Nonlimiting examples of suitable silicon-based resins may be found in Application Publication Nos. 2011/0098394 (pending), 2010/0179281 (pending), and U.S. Pat. Nos. 8,168,739 and 8,261,833, the entire disclosures of which are herein incorporated by reference. Nonlimiting examples of suitable binders may be found in U.S. Pat. Nos. 8,003,579; 7,825,074; and 6,287,639, as well as U.S. Patent Application Publication No. 2011/0039737, the entire disclosures of which are herein incorporated by reference. It is within the ability of one skilled in the art, with the benefit of this disclosure, to determine the type and amount of consolidating agent to include in the methods of the present invention to achieve the desired results.

In some embodiments of the present invention, degradable particulates are included with the cementitious or expandable cementitious material. One purpose of including degradable particulates is to enhance the permeability of the conductivity of the fracture. In some embodiments, the degradable particles used are oil-degradable materials, which degrade by produced fluids. In other embodiments, the degradable particulates may be degraded by materials purposely placed in the formation by injection or mixing the degradable particle with delayed reaction degradation agents, or other suitable means to induce degradation. In embodiments in which degradable particulates are used, the degradable particulates are preferably substantially uniformly distributed throughout the cementitious material. Over time, the degradable material will degrade, in situ, causing the degradable material to substantially be removed from the cured cementitious material and to leave behind voids. These voids may enhance the conductivity of the fracture.

Suitable degradable particulates include oil-degradable polymers. Oil-degradable polymers that may be used in accordance with the present invention may be either natural or synthetic polymers. Some particular examples include, but are not limited to, polyacrylics; polyamides; and polyolefins such as polyethylene, polypropylene, polyisobutylene, and polystyrene. Other suitable oil-degradable polymers include those that have a melting point which is such that the polymer will melt or dissolve at the temperature of the subterranean formation in which it is placed, such as a wax material.

In addition to oil-degradable polymers, other degradable particulates that may be used in conjunction with the present invention include, but are not limited to, degradable polymers; dehydrated salts; and/or mixtures of the two. As for degradable polymers, a polymer is considered to be “degradable” herein if the degradation is due to, in situ, a chemical and/or radical process such as hydrolysis, or oxidation. The degradability of a polymer depends at least in part on its backbone structure. For instance, the presence of hydrolyzable and/or oxidizable linkages in the backbone often yields a material that will degrade as described herein. The rates at which such polymers degrade are dependent on, at least, the type of repetitive unit, composition, sequence, length, molecular geometry, molecular weight, morphology (e.g., crystallinity, size of spherulites, and orientation), hydrophilicity, hydrophobicity, surface area, and additives. Also, the environment to which the polymer is subjected may affect how it degrades (e.g., formation temperature, presence of moisture, oxygen, microorganisms, enzymes, pH, and the like).

Suitable examples of degradable polymers that may be used in accordance with the present invention include polysaccharides such as dextran or cellulose; chitins; chitosans; proteins; aliphatic polyesters; poly(lactides); poly(glycolides); poly(ε-caprolactones); poly(hydroxybutyrates); poly(anhydrides); aliphatic or aromatic polycarbonates; poly(orthoesters); poly(amino acids); poly(ethylene oxides); and polyphosphazenes. Of these suitable polymers, aliphatic polyesters and polyanhydrides may be preferred. Polyanhydride hydrolysis proceeds, in situ, via free carboxylic acid chain-ends to yield carboxylic acids as final degradation products. The degradation time can be varied over a broad range by changes in the polymer backbone. Examples of suitable polyanhydrides include poly(adipic anhydride), poly(suberic anhydride), poly(sebacic anhydride), and poly(dodecanedioic anhydride). Other suitable examples include, but are not limited to, poly(maleic anhydride) and poly(benzoic anhydride).

Dehydrated salts may be used in accordance with the present invention as a degradable particulates. A dehydrated salt is suitable for use in the present invention if it will degrade over time as it hydrates. For example, a particulate solid anhydrous borate material that degrades over time may be suitable. Specific examples of particulate solid anhydrous borate materials that may be used include, but are not limited to, anhydrous sodium tetraborate (also known as anhydrous borax) and anhydrous boric acid. These anhydrous borate materials are only slightly soluble in water. However, with time and heat in a subterranean environment, the anhydrous borate materials react with the surrounding aqueous fluid and are hydrated. The resulting hydrated borate materials are highly soluble in water as compared to anhydrous borate materials and as a result degrade in the aqueous fluid. In some instances, the total time required for the anhydrous borate materials to degrade in an aqueous fluid is in the range of from about 8 hours to about 72 hours depending upon the temperature of the subterranean zone in which they are placed. Other examples include organic or inorganic salts like acetate trihydrate.

Blends of certain degradable materials may also be suitable as degradable particulates. One example of a suitable blend of materials is a mixture of poly(lactic acid) and sodium borate where the mixing of an acid and base could result in a neutral solution where this is desirable. Another example would include a blend of poly(lactic acid) and boric oxide. Other materials that undergo an irreversible degradation may also be suitable, if the products of the degradation do not undesirably interfere with either the conductivity of the proppant matrix or with the production of any of the fluids from the subterranean formation.

In some embodiments of the present invention, the degradable particulates are present in the range from about 1% to about 90% by weight of the combined total of cementitious material and degradable particulates. In other embodiments, the degradable particulates are present in the range from about 20% to about 70% by weight of the combined total of cementitious material and degradable particulates. In still other embodiments, the degradable particulars are present in the range from about 25% to about 50% by weight of the combined total of cementitious material and degradable particulates. One of ordinary skill in the art with the benefit of this disclosure will recognize an optimum concentration of degradable particulates that provides desirable values in terms of enhanced conductivity or permeability without undermining the stability of the propped fracture itself.

In some embodiments, the present invention provides a method comprising providing a wellbore in a subterranean formation having at least one fracture; providing a cement slurry comprising a cementitious or expandable cementitious material and a breakable foamed carrier fluid, wherein the cementitious or expandable cementitious material is capable of consolidating to form a plurality of cementitious or expandable cementitious material aggregates and wherein the breakable foamed carrier fluid is capable of coating and isolating the cementitious or expandable cementitious material aggregates; introducing the cement slurry into the at least one fracture in the subterranean formation; curing the cementitious or expandable cementitious material aggregates so as to form a cement pillar within the fracture in the subterranean formation; degrading the breakable foamed carrier fluid; and removing the degraded breakable foamed carrier fluid from the subterranean formation. In some embodiments, the fracture may be acid-fracturized after placement and curing of the cement pillars into the fracture.

As used herein, the term “foam” refers to a two-phase composition having a continuous liquid phase and a discontinuous gas phase. The breakable foamed carrier fluid of the present invention is capable of surrounding cementitious material aggregates and preventing or reducing their dispersal when being placed in a fracture, particularly in high shear areas. By preventing dispersal of the cementitious material aggregates, discrete cementitious material aggregates may be placed into a fracture and cured therein to form a cement pillar, which aid in propping the fracture and enhancing conductivity of the fracture.

The breakable foamed carrier fluid of the present invention may be a foamed version of any fluid suitable for use as a base fluid or substantially particulate-free pad fluid of the present invention (e.g., a foamed aqueous-based fluid, a foamed oil-based fluid, a foamed water-in-oil emulsion, or a foamed oil-in-water emulsion). The breakable foamed carrier fluid of the present invention is preferably substantially particulate-free. The breakable foamed carrier fluid of the present invention may comprise a nano-particle, a foaming agent, a foam breaker, and/or a gas generating agent.

Nano-particles may be included in the breakable foamed carrier fluid in order to enhance the stability and toughness of the generated foam. In preferred embodiments, a nano-particle is included in the breakable foamed carrier fluid to enhance its ability to surround and protect the cementitious or expandable cementitious material aggregates being placed into a fracture. Suitable nano-particles may include, but are not limited to, fumed silica; a phyllosilicate; and any combination thereof. In some embodiments, the nano-particulates are present in the present invention in the range from about 0.1% to about 10% by volume of the breakable foamed carrier fluid. In preferred embodiments, the nano-particulates are present in the present invention in the range from about 1% to about 5% by volume of the breakable foamed carrier fluid.

Suitable foaming agents for use in the present invention may include, but are not limited to, an ethoxylated alcohol ether sulfate; an alkyl amidopropyl betaine; an alkene amidopropyl betaine surfactant; an alkyl amidopropyl dimethyl amine oxide; and alkene amidopropyl dimethyl amine oxide; any derivatives thereof; and any combinations thereof. In some embodiments, the foaming agent is present in the breakable foamed carrier fluid of the present invention in an amount of about 0.01% to about 10% by volume of the breakable foamed carrier fluid. In preferred embodiments, the foaming agent is present in the breakable foamed carrier fluid of the present invention in an amount of about 0.1% to about 2% by volume of the breakable foamed carrier fluid.

Foam breakers function to reduce or hinder already produced foam or the future production of foam. Foam breakers are able to rupture air bubbles and degrade foam. In doing so, foam breakers are able to reduce the viscosity of foamed breakable foamed carrier fluids in order to aid, for example, in producing (or removing) fluids back to the surface of the subterranean formation. In preferred embodiments of the present invention, the foam breaker may be encapsulated with a coating (e.g., a porous coating through which the foam breaker may diffuse slowly, or a degradable coating that degrades downhole upon an activating condition, such as, for example, pH or temperature). The coating encapsulating the foam breaker may serve to minimize interference between the foam breaking and the foaming agent such that the foaming agent is able to produce foam and the foam is broken only upon certain conditions, such as the duration or time the breakable foamed carrier fluid has been downhole, temperature, pH, salinity, and the like. For use in the present invention, suitable foam breakers include any known oil-based foam breakers; water-based foam breakers; silicone-based foam breakers; polymer-based foam breakers; alkyl polyacrylate foam breakers; and any combinations thereof. Suitable oil-based foam breakers may comprise an oil carrier and a wax component. The oil carrier may include, but is not limited to, mineral oil; vegetable oil; white oil; any other oil insoluble in the breakable foamed carrier fluid; and any combinations thereof. The wax may include, but is not limited to, ethylene bis stearamide; paraffin wax; ester wax; fatty alcohol wax; and any combination thereof. In addition, the oil-based foam breakers of the present invention may include a hydrophobic silica. Suitable water-based foam breakers for use in the breakable foamed carrier fluid of the present invention may comprise a water carrier and an oil component or a water carrier and a wax component. The oil component may include, but is not limited to, white oil; vegetable oil; and any combinations thereof. The wax component may include, but is not limited to, a long chain fatty alcohol wax; a fatty acid soap wax; an ester wax; and any combinations thereof. Suitable silicone-based foam breakers may comprise a hydrophobic silicone component dispersed in a silicone oil. The silicone-based foam breaker may additionally comprise silicone glycols or other modified silicones. Suitable polymer-based foam breakers may comprise polyethylene glycol and polypropylene glycol copolymers and may be delivered in an oil carrier, a water carrier, or an emulsion base. Suitable alykyl polyacrylate foam breakers may comprise an oil carrier and an alykyl polyacrylate. In some embodiments, the foam breaker is present in the breakable foamed carrier fluid of the present invention in an amount in the range from about 0.1% to about 10% by volume of the breakable foamed carrier fluid. In preferred embodiments, the foam breaker is present in the breakable foamed carrier fluid of the present invention in an amount in the range from about 0.5% to about 3% by volume of the breakable foamed carrier fluid.

The breakable foamed carrier fluid of the present invention may also comprise a gas generating agent. Gas generating agents may aid the foaming agent in producing foam. Some gas generating agents may be capable of forming a foam without the aid of a foaming agent. Suitable gas generating agents for use in conjunction with the present invention may include, but are not limited to, nitrogen; carbon dioxide; air; methane; helium; argon; and any combination thereof. One skilled in the art, with the benefit of this disclosure, should understand the benefit of each gas. By way of nonlimiting example, carbon dioxide foams may have deeper well capability than nitrogen foams because carbon dioxide gas foams have greater density than nitrogen gas foams so that the surface pumping pressure required to reach a corresponding depth is lower with carbon dioxide than with nitrogen. In some embodiments, the foam quality of the breakable foamed carrier fluid may range from a lower limit of about 5%, 10%, 25%, 40%, 50%, 60%, or 70% gas volume to an upper limit of about 95%, 90%, 80%, 75%, 60%, or 50% gas volume, and wherein the foam quality of the breakable foamed carrier fluid may range from any lower limit to any upper limit and encompass any subset therebetween. Most preferably, the breakable foamed carrier fluid may have a foam quality from about 85% to about 95%, or about 90% to about 95%.

Any of the fluids or cementitious materials of the present invention may further comprise an additive including, but not limited to, a salt; a weighting agent; an inert solid; a fluid loss control agent; a dispersion aid; a corrosion inhibitor; a viscosifying agent; a gelling agent; a surfactant; a particulate; a proppant particulate; a gravel particulate; a lost circulation material; a pH control additive; a breaker; a biocide; a crosslinker; a stabilizer; a scale inhibitor; a friction reducer; and any combinations thereof.

In some embodiments, the cementitious or expandable cementitious material aggregates of the present invention are introduced into a fracture alone or intermittently between a substantially particulate-free pad fluid so as to create spaced cementitious material portions flanked by the substantially particulate-free pad fluid. After the cementitious or expandable cementitious material aggregates cure, the substantially particulate-free pad fluid may be returned to the surface such that individual cement pillars remain in the fracture. Any suitable base fluid may be used as a substantially particulate-free pad fluid of the present invention, provided that the substantially particulate-free pad fluid is substantially particulate-free. As used herein, the term “substantially particulate-free fluid” refers to a fluid having a particulate volume of no more than about 60% by weight of the substantially particulate-free fluid.

In some embodiments, the present invention provides a method comprising providing a wellbore or a lateral wellbore in a subterranean formation having a top portion and a bottom portion, and a middle portion therebetween; providing a jetting fluid comprising a base fluid and a cutting particulate; providing a cement slurry comprising an expandable cementitious material; and providing a breakable gel fluid. The jetting fluid is then introduced into the bottom portion of the wellbore in the subterranean formation at a pressure sufficient to create or enhance a bottom portion fracture therein and thereafter introduced into the top portion of the wellbore in the subterranean formation at a pressure sufficient to create or enhance a top portion fracture therein. Next, the cement slurry is introduced first into the top portion fracture and then into the bottom portion fracture. The breakable gel fluid is introduced into the wellbore or lateral wellbore so as to prevent the expandable cementitious material from migrating out of the top portion fracture and bottom portion fracture in the subterranean formation. The expandable cementitious material is cured so as to form a cement pack, wherein the curing of the expandable cementitious material expands the expandable cementitious material such that at least one microfracture is created within top portion fracture and the bottom portion fracture in the subterranean formation and the breakable gel fluid is broken and removed from the subterranean formation. In some embodiments, the broken breakable gel fluid may be removed by circulating a base fluid with or without the additives disclosed herein. In some embodiments, the base fluid may be circulated using a hydrojetting tool.

A hydrojetting tool may be used to create or enhance the top and bottom fractures of the present invention and, when used, it can be repositioned within the wellbore so as to sequentially create fractures along the length of the wellbore. In some embodiments, a hydrojetting tool is used to create a first fracture at the bottom portion of the wellbore and is then repositioned along the middle portion and up to the top portion of the wellbore in order to create multiple fractures along the length of the wellbore, ending with the top portion. In some embodiments, the fractures are created through perforations or slots in the subterranean formation. Any means of creating fractures in subterranean formations known to those of ordinary skill in the art may also be used with the methods of the present invention.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

The invention claimed is:

1. A method comprising:
providing a wellbore in a subterranean formation having at least one fracture;
providing an expandable cementitious material;
introducing the expandable cementitious material into the at least one fracture in the subterranean formation;
curing the expandable cementitious material so as to form a cement pack,
wherein the curing of the expandable cementitious material expands the expandable cementitious material such that at least one microfracture is created within the at least one fracture in the subterranean formation; and
acid-fracturing the at least one fracture in the subterranean formation.

2. The method of claim 1 wherein the at least one fracture in the subterranean formation is created through a slot or a perforation in the subterranean formation.

3. The method of claim 1 wherein the expandable cementitious material comprises an expandable agent selected from the group consisting of calcium oxide; magnesium oxide; any derivatives thereof.

4. The method of claim 1 wherein the expandable cementitious material is capable of withstanding the in-situ stresses of the subterranean formation.

5. The method of claim 1 wherein the expandable cementitious material is capable of acting as a barrier against direct hydraulic fracture growth.

6. The method of claim 1 wherein a breakable gel fluid is introduced into the wellbore in the subterranean formation after introducing the expandable cementitious material so as to prevent the expandable cementitious material from migrating out of the at least one fracture in the subterranean formation and wherein the breakable gel fluid is broken and removed from the subterranean formation after the curing of the expandable cementitious material and before the acid-fracturing of the at least one fracture in the subterranean formation.

7. A method comprising:
providing a wellbore in a subterranean formation having at least one fracture;
providing an expandable cementitious material;
introducing the expandable cementitious material into the at least one fracture in the subterranean formation; and
curing the expandable cementitious material so as to form a cement pack,
wherein the curing of the expandable cementitious material expands the expandable cementitious material such that at least one microfracture is created within the at least one fracture in the subterranean formation.

8. The method of claim 7 wherein the at least one fracture in the subterranean formation is acid-fracturized after the curing of the expandable cementitious material.

9. The method of claim 7 wherein the at least one fracture in the subterranean formation is created through a slot or a perforation in the subterranean formation.

10. The method of claim 7 wherein the expandable cementitious material comprises an expandable agent selected from the group consisting of calcium oxide; magnesium oxide; any derivatives thereof.

11. The method of claim 7 wherein the expandable cementitious material further comprises a consolidating agent.

12. The method of claim 7 wherein the expandable cementitious material further comprises degradable particulates.

13. The method of claim 7 wherein the expandable cementitious material is capable of withstanding the in-situ stresses of the subterranean formation.

14. The method of claim 7 wherein the expandable cementitious material is capable of acting as a barrier against direct hydraulic fracture growth.

15. The method of claim 7 wherein a breakable gel fluid is introduced into the wellbore in the subterranean formation after introducing the expandable cementitious material so as to prevent the expandable cementitious material from migrating out of the at least one fracture in the subterranean formation and wherein the breakable gel fluid is broken and removed from the subterranean formation after the curing of the expandable cementitious material.

16. The method of claim 7 wherein a breakable gel fluid is introduced intermittently into the at least one fracture between introducing the expandable cementitious material so as to alternate the breakable gel fluid and the expandable cementitious material within the at least one fracture in the subterranean formation and wherein the breakable gel fluid is broken and removed from the subterranean formation after the curing of the expandable cementitious material.

17. A method comprising:
providing a wellbore in a subterranean formation having at least one fracture;
providing an expandable cementitious material;
providing a breakable gel fluid;
introducing the expandable cementitious material into the at least one fracture in the subterranean formation;
introducing the breakable gel fluid into the wellbore in the subterranean formation so as to prevent the expandable cementitious material from migrating out of the at least one fracture in the subterranean formation;
curing the expandable cementitious material so as to form a cement pack,
wherein the curing of the expandable cementitious material expands the expandable cementitious material such that at least one microfracture is created within the at least one fracture in the subterranean formation;
breaking the breakable gel fluid; and
removing the broken breakable gel fluid from the subterranean formation.

18. The method of claim 17 wherein the at least one fracture in the subterranean formation is acid-fracturized after the removal of the broken breakable gel fluid.

19. The method of claim 17 wherein the at least one fracture in the subterranean formation is created through a slot or a perforation in the subterranean formation.

20. The method of claim 17 wherein the expandable cementitious material comprises an expandable agent selected from the group consisting of calcium oxide; magnesium oxide; any derivatives thereof.
